(19) United States
(12) Patent Application Publication
(10) Pub. No.: US 2024/0152401 A1
(43) Pub. Date: May 9, 2024

(54) AUTOMATION FRAMEWORK FOR MULTI-CLOUD QUOTA MANAGEMENT

(71) Applicant: SAP SE, Walldorf (DE)

(72) Inventor: Showkath Ali Naseem, Anantapur (IN)

(21) Appl. No.: 18/053,139

(22) Filed: Nov. 7, 2022

(51) Int. Cl. G06F 9/50

(52) U.S. Cl. CPC G06F 9/505; G06F 9/5077; G06F 2209/501; G06F 2209/5022

(57) ABSTRACT

In some implementations, a method including receiving, at a quota management application, resource usage information for at least a first cloud platform of a plurality of cloud platforms of a multi-cloud system; analyzing, at the quota management application, the resource usage information to determine the resource usage information of a first resource at the first cloud platform exceeds a first quota threshold for the first resource; in response to the first quota threshold being exceeded, sending, by the quota management application, a request to a workflow processor to request an increase in a quota for the first resource; and in response to receiving a response to the request indicative of a grant of the increase, sending a resource request towards the first cloud platform, wherein the resource request indicates the increase in the quota for the first resource. Related systems, methods, and articles of manufacture are also disclosed.

### TECHNICAL FIELD

This disclosure relates generally to multi-cloud technology.

### BACKGROUND

Database management systems have become an integral part of many computer systems. For example, some systems handle hundreds if not thousands of transactions per second (which in-turn can generate over time a large volume of corresponding data). On the other hand, some systems perform very complex multidimensional analysis on data. In both cases, the underlying database may need to handle responses to queries very quickly in order to satisfy systems requirements with respect to transaction time. Given the complexity of these queries and/or their volume, the underlying databases face challenges in order to optimize performance including use of resources, such as memory and storage.

### SUMMARY

In some implementations, there is provided a computer-implemented method including receiving, at a quota management application, resource usage information for at least a first cloud platform of a plurality of cloud platforms of a multi-cloud system; in response to the received resource usage information, storing, by the quota management application, the resource usage information to provide local use of the resource usage information; analyzing, at the quota management application, the resource usage information to determine the resource usage information of a first resource at the first cloud platform exceeds a first quota threshold for the first resource; in response to the first quota threshold being exceeded, sending, by the quota management application, a request to a workflow processor to request an increase in a quota for the first resource; and in response to receiving a response to the request indicative of a grant of the increase, sending, by the quota management application, a resource request towards the first cloud platform, wherein the resource request indicates the increase in the quota for the first resource.

In some variations, one or more of the features disclosed herein including the following features can optionally be included in any feasible combination. The quota management application may include a front-end component, a backend component, a database, a communication service, and the workflow processor. The front end component may provide an interface to view, control, monitor, and/or access resource usage at the plurality of cloud platforms of the multi-cloud system. The front end component may provide via the interface a centralized dashboard to view and monitor the resource usage information at the plurality of cloud platforms of the multi-cloud system, wherein the resource usage information may include a current amount of database instances, a current amount of processor being used, a current amount of memory being used, a current amount of storage being used, and a current amount network bandwidth being used. The backend component may include one or more rules to monitor and analyze the resource usage information at the plurality of cloud platforms of the multi-cloud system. The communication service may provide an interface with at least an infrastructure service to centralize access to the plurality of cloud platforms of the multi-cloud system. The communication service may include a publish and subscribe system between the quota management application and the plurality of cloud platforms. The resource usage information for at least the first cloud platform may be received as a publish and subscribe message from the infrastructure service, wherein the publish and subscribe message may be published by the infrastructure service in response to a change to the resource usage information at the first cloud platform. The database may provide a local store for the resource usage information, the first quota threshold, and the one or more rules to monitor and analyze the resource usage information at the plurality of cloud platforms of the multi-cloud system. In response to receiving the response to the request indicative of the grant of the increase, sending, by the quota management application, a message to application using the first resource, the message indicating to the application of the increase in the quota for the first resource to enable the application to use the increase.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

In the drawings,

FIG. 1 depicts a diagram illustrating an example of a system including a quota management application, in accordance with some embodiments;

FIG. 2A depicts another example of system including a multi-cloud environment and a quota management application, in accordance with some embodiments;

FIG. 2B depicts an example of a process for controlling a quota at a cloud service provider, in accordance with some embodiments;

FIG. 3 depicts another example of a process for controlling a quota at a cloud service provider, in accordance with some embodiments; and

FIG. 4 depicts another example of a system, in accordance with some embodiments;

### DETAILED DESCRIPTION

Multi-cloud technology refers to cloud computing where multiple clouds are used, such as private cloud providers, public cloud providers, of a combination thereof to provide services. In a multi-cloud environment for example, an entity may have an application deployed to different cloud service providers. For example, a company may have database management system instances deployed in an SAP cloud service as well as other providers of cloud services. In this example, the company may have quotas indicating the amount of resources allowed (e.g., allocated) at each of the cloud service providers. Moreover, each of the cloud service providers may have different technologies and ways of expressing resources, such as quantity of instances allowed at any given time, CPU resources allocated, memory resources allocated, disk or persistent storage resources allocated, network bandwidth resources allocated, and/or the like.

If at a given cloud service provider, the company exceeds an assigned or allocated quota for a resource, this may affect currently running application instances and can prevent the starting new application instances, for example. From the perspective of the company in this example, this can be seen as an outage. Although the company can request additional resources from a cloud service provider, this may occur after the resource quota has been exceeded. For example, a database instance may at a given time exceed its memory allocation for a variety of reasons. In this example, the database instance exceeding its quota impacts the operations of the company's other database instances and/or application at the cloud service provider where the quota was exceeded. As such, there is a need to provide a proactive and automatic way to detect when a resource quota might be exceeded, and before the quota is exceeded, automatically assign more resources before the quota is exceeded-preventing thus a failure or error causing an outage. To that end, there is provided a quota management application (QMA) to monitor and analyze current resource usage at a cloud platform and proactively assign additional resources when a threshold amount of the resource quota is exceeded.

Before providing additional details regarding quota management application (QMA), the following provides an example of a system environment.

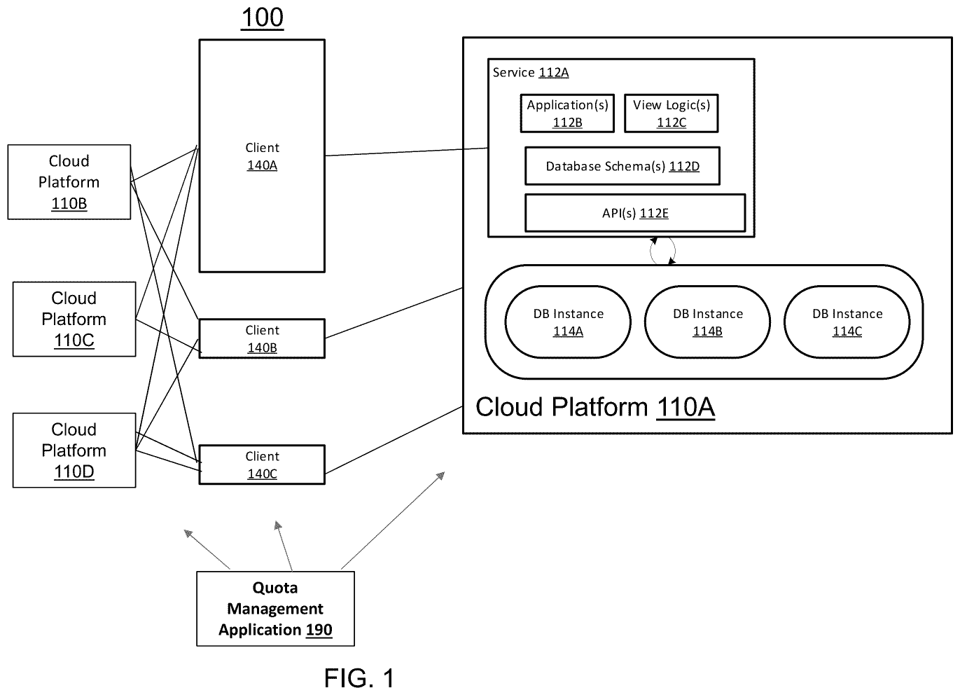

FIG. 1 depicts a diagram illustrating an example of a system 100 consistent with some implementations of the current subject matter. Referring to FIG. 1, the system 100 may include a plurality of cloud platforms 110A-D. Each of the cloud platforms may provide resources that can be shared among a plurality of tenants. For example, the cloud platforms 110A-D may be configured to provide a variety of services including, for example, software-as-a-service (SaaS), platform-as-a-service (PaaS), infrastructure as a service (IaaS), database as a service (DaaS), and/or the like, and these services can be accessed by one or more tenants (labeled clients) of the cloud platform. FIG. 1 also depicts a quota management application (QMA) configured to at last monitor and analyze current resource usage and proactively assign additional resources when a threshold amount of the resource quota is exceeded.

In the example of FIG. 1, the system 100 includes a first tenant 140A, a second tenant 140B, and a third tenant 140C, although other quantities of tenants (which as noted are labeled as tenants) may be implemented as well on the cloud platform 110A. A user may access the client, and the clients may each comprise a user device (e.g., a computer including an application such as a browser or other type of application). And, the clients may each access, via the Internet and/or other type of network or communication link(s), at least one of the services at a cloud platform, such as cloud platform 110A-D. In some implementations, each of the clients/tenants 140A-C represents a separate tenant at the cloud platform 110A for example, such that a tenant's data is not shared with other tenants (absent permission from a tenant). Alternatively, each of the tenants 140A-C may represent a single tenant at the cloud platform 110A, such that the tenants do share a portion of the tenant's data, for example.

The cloud platform 110A may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources.

In the case of a cloud platform being a so-called “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants.

Alternatively, or additionally, the cloud platform may be a “private” cloud platform, in which case the resources of the cloud platform may be hosted on an entity's own private servers (e.g., dedicated corporate servers operated and/or owned by the entity).

Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110A includes a service 112A, which is provided to for example the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110A.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110A. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110A. Although the database instances are depicted at the same cloud platform 110A, one or more of the database instances may be hosted on another or separate platform (e.g., on premise) and/or another cloud platform. Moreover, the service provided at the cloud platform may include other types of applications, such user interface applications, and the like.

The cloud platforms 110A-D may (as noted) be implemented using different technologies. As such, a system having heterogeneous cloud platforms may include for example, deployments at a SAP cloud, Microsoft Azure™, Amazon Web Services™, Google Cloud Platform™ data centers, a private data center, and/or the like.

Moreover, the databases instances at the cloud platform may may rely on the same or different storage or database technology. For example, a database management system instance may be an online transaction processing (OLTP) system using a relational database system. An example of an OLTP system is the SAP S/4HANA™ enterprise resource planning (ERP) system. Furthermore, the database management system instance may operate using for example the same or different storage technology, such as a row-oriented database system, a column-oriented database system, or a hybrid row-column store approach. Alternatively, or additionally, the database management system instance may be for example an online analytic processing (OLAP) system. Applications of OLAP systems include business reporting for sales, marketing, management reporting, business process management (BPM), budgeting, forecasting, financial reporting, and/or other types of analytics. An example of the OLAP system is the SAP BW/4HANA™ data warehouse solution, which can be used to for example answer multi-dimensional analytical (MDA) queries.

To provide SaaS, IaaS, PaaS, DaaS, and other service in a multi-cloud environment, these services may be provided via a private cloud service, a public cloud service, or via a combination of public and private. To provide these services to a user, via a tenant or client, the services may be provided and categorized by an account, such as services for entity A. This account may be organized into subaccounts by region, geographical area, roles, and/or some other sub-categorization schema. For example, a company may organize its cloud services based on region and use cloud platforms available in that region. And for example, an account may be configured to provide services based on a model, such as a consumption-based model or a subscription-based model. In a consumption based model, the entity receives access to, for example, all services under the model, while in a subscription based model the entity only subscribes to one or more services at a fixed cost (without regard to consumption).

Under the above-noted models, an entity (e.g., a company accessing a cloud provider as a tenant) may receive an allocation of resources. For example, company X may receive resources in the form of: 10 database instances hosted on 4 CPUs with 1 Gigabyte (GB) memory and 1 GB of network bandwidth. In this example, the allocated resources are monitored to make sure that company X does not exceed the allocated resources (or quota) that has been allocated to company X under the model. The quotas allocated may thus represent operational limits, such as a maximum quantity of allocated CPUs, maximum memory usage, maximum network bandwidth, quantity of allowed application instances, and the like. In this way, the cloud service provider monitors company X's usage to ensure it does not exceed its allocated resources (otherwise, company X may be unfairly using resources it has not paid for and/or allocated to another entity). To illustrate further, a cloud service provider providing cloud platform 110A would not want company X to exceed its quota for storage, The quotas may be enforced at the account level (e.g., for company X), at the subaccount level (e.g., company X region A), or in other ways as well.

In some instances, high memory consumption may be a common occurrence for an application, such as a database instances. When this is the case, the cloud service provider may provide an exemption process to determine whether the application should be granted additional resources, which in this example is additional memory. For example, a service ticket may be generated and sent to a cloud service provider's controller to request additional resources, such as the additional memory. The request may then be validated (and/or approved) to check whether additional memory should be allocated to the entity requiring additional resources such as memory and/or whether additional memory is actually available to be allocated. If the entity is allowed to receive the additional resources and the resources are available, a controller or other mechanism may respond to the request to indicate that additional resources such as memory can be allocated and assigned to the entity's account or subaccount. And in some instances, the underlying application, such as the database instance, may be configured to use the additional of resource, such as the memory allocation.

To illustrate further, when an application is deployed to a cloud platform (or service), the deployment can fail if a resource allocation is exceeded. This may take the form of “Deployment FAILED—organization's memory limit exceeded: staging requires xxx (2048M) memory.” Likewise, when a new service is being provisioned to the cloud platform, if any of the quotas seem insufficient, provisioning can fail with an error indicating quota count exceeded for the account, subaccount, database instance, and/or the like such as the following error indication: “Total database service instance count in this entity is exceeded, can't create service instance.” When an overall, global quota (for a given account or subaccount for an entity at a cloud platform) is reached for a service or application, new instances of the service/application may cannot be created, currently running applications can crash, and the rollout of patches and fixes can be inhibited, all of which affects the overall reliability or availability of the service (or application which in this example is a database instance).

In some embodiments, there is provided a proactive, intelligent system that monitors and analyzes current quotas for a given entity, and if the current quota cannot support the required tenants, the system automatically triggers a process to change the allocated quota. In a multi-cloud platform environment where an entity, such as company X, has database instances deployed at (or on) different cloud platforms for example, the system disclosed herein may automatically triggers a process to change the allocated quota when the current usage approaches (or is expected to reach) a threshold of the quota.

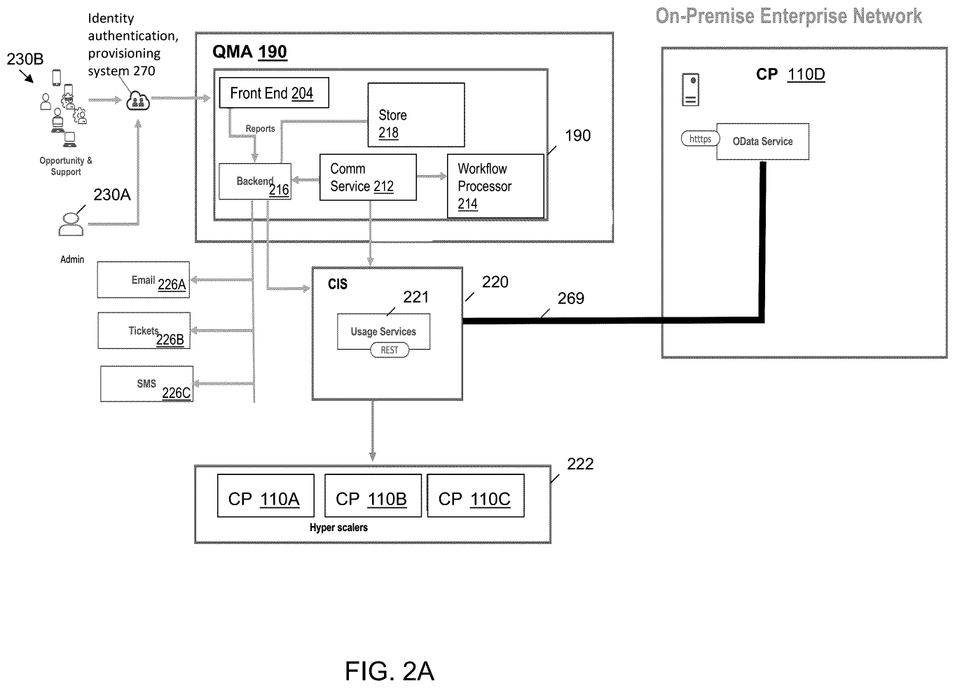

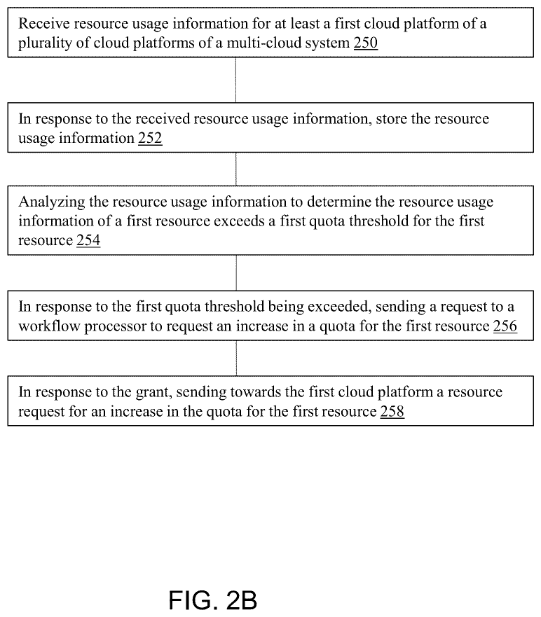

FIG. 2A depicts an example of system 200 including a quota management application (QMA) 190, in accordance with some embodiments.

The QMA 190 may include a front-end application 204, backend services 216, store 218, a communication service 212 (e.g., a publish and subscribe service), and a workflow processor 214.

The front-end application 204 may be accessed by a tenant (or client) device being accessed by users (e.g., an administrator 230A or other users 230B) to view, control, monitor, and/or access resource usage at one or more of the cloud platforms 110A-D of the multi-cloud environment 222. For example, the front-end application 204 may be accessed to generate one or more reports regarding the resource usage at one or more of the cloud platforms. Moreover, the front-end application 204 may be accessed to request changes to resource usage (e.g., increase or decrease in resource allocation), change or modify rules such as one or more quota threshold rules, and/or perform other operations.

In some embodiments, the front-end application 204 may provide a centralized dashboard to view and monitor: the quota resource usage at one or more of the cloud platforms 110A-D of the multi-cloud environment 222 (e.g., current amount of database instances, current amount of CPU used, current amount of memory used, current amount of storage used, current amount network bandwidth used, and the like), assigned quota at one or more of the cloud platforms of the multi-cloud environment (e.g., a maximum assigned amount of database instances, a maximum assigned amount of CPU resources, a maximum assigned amount of memory resources, a maximum amount of storage assigned, a maximum assigned amount network bandwidth resources, and the like), amount remaining in the quota at one or more of the cloud platforms 110A-D of the multi-cloud environment 222, and/or the like.

The backend services 216 may include one or more rules configured to monitor and/or analyze current resource usage, determine whether resource usage exceeds one or more thresholds (e.g., “quota threshold rules”), cause storage of current resource usage, trigger workflow processes, and/or perform other operations. Moreover, the one or more rules may take the form of policies that configure the system 200 to automatically scale up (or down) a quota for a given resource. These rules may be pre-configured. Alternatively, or additionally, the rules may be a default set of rules. Alternatively, or additionally, the rules may be a defined via the front end 204 and stored at the store 218. The devices 230A-B may access the MA via an interface, such as an identity authentication and provisioning system 270. For example, the policy may take the form of instructions (e.g., code, script, and/or a configuration file) including one or more conditions (e.g., current usage of a resource exceeding a quota threshold) that will trigger an increase (e.g., scale up) or decrease (e.g., scale down) in the quota for a resource assigned to an entity at a cloud platform. These conditions may be configured to be a percentage of a given value. For example, if a database instance at a given cloud platform provides 1 Gigabyte of memory for the database instance, the quota threshold may be set below 1 Gigabyte to proactively trigger an alert or message. For example, the quota threshold may be pre-configured, a default value, and/or defined via the front end 204 and stored at the store 218.

The communication service 212 may provide a publish and subscribe service that publishes events (e.g., updates or changes to resource usage information 221 as well as other types of updates or changes to information) to subscribers, such as backend services (BS) 216. The publish and subscribe service provided at 220 may enable one or more consumers to subscribe to and track quota usage and receive real time alerts regarding quotas. The publish and subscribe service may thus provide asynchronous and real time messaging between QMA 190 and other consumers, such as a commerce infrastructure services (CIS) 220, workflow processor 214, and/or other consumers, such as 230A-B. In the example of FIG. 2A, the publish and subscribe service 220 may access the cloud platform 110D via a secure tunnel 269.

The workflow processor 214 provides an automated workflow for the processing of a request for cloud service resources. When BS 216 requests additional resources for an entity at a given cloud platform, the BS sends the request with a request to the workflow processor, which responds with an accept or deny of the request for the additional resource(s).

In some embodiments, the store 218 may store data for the QMA 190. The stored data may include quotas, current usage, configuration information, transaction details, tickets, logs, and/or other information. The store 218 may be implemented as a database, a database as a service, and/or an in-memory database (e.g., as a database as a service (DaaS) providing an in-memory database).

The QMA 190 may comprised in a cloud service, a stand-alone application (e.g., separate from the cloud platforms 110A-B), and/or the like.

In operations, the cloud infrastructure service (CIS) 220 may provide resource usage information for the resources at each of the cloud platforms 110A-D in the multi-cloud environment 222. For example, the CIS 220 may provide (via the communication service 212) resource usage information 221 to the BS 216. Examples of the resource usage information 221 include: quantity of application instances (e.g., database instances) currently being used by an entity at a given cloud platform, a quantity of CPUs (which may be per instance) currently being used by an entity at a given cloud platform, a quantity of memory currently being used by an entity at a given cloud platform, network bandwidth currently being used by an entity at a given cloud platform, and/or other usage information. The resource usage information may include current resource usage information at a given cloud platform (resources currently being used at a given cloud platform). Alternatively, or additionally, resource usage information may include the quotas (e.g., maximum amount of each resource an entity is allowed to use at a given cloud platform). In this example, the entity may be a company (e.g., a tenant of a multi-tenant system) or a portion of that entity (e.g., a region for the tenant or a type of application such as database instances).

In some embodiments, the communication service may be, as noted, a publish and subscribe service, in which case when there is a change to the resource usage information 221 at the CIS 221, the change is published (e.g., sent) to subscribers, such as the backend services 216. The backend services 216 may include one or more rules, such as quota threshold rules.

Returning to the previous example, when there is a change to the resource usage information 221 at the CIS 221, the BS 216 receives (as a result of the publication) an indication of the update (e.g., the change or update to the resource usage information) and stores the updated resource usage information at the store 218. Moreover, the BS 216 may analyze the change data using one or more quota threshold rules to determine whether the current resource usage is approaching or exceeding the quota for that resource. For example, the current resource usage for a database instance at cloud service platform 110A may increase such that exceeds or approaches a threshold for memory allocated to the database instance. For example, the threshold may be set to 90% of the quota for memory resources at cloud service platform 110 (although the threshold may be set to other value, such as 75%, 80%, 91%, 92%, 93%, 94%, 95%, and/or other threshold values as well). When the current resource usage of memory reaches the 90% quota threshold for example, the 90% quota threshold rule automatically triggers a request for an increase in the memory allocation to be sent (via the communication service 212) towards the workflow processor 214. The resource request may include one or more of the following: (1) an identify of the entity requesting the change in resource allocation (e.g., company X and/or region GE), (2) an identity of the application (e.g., HANA database instance), (3) current resource usage (e.g., the current memory usage), (4) an amount of resource increase requested (e.g., an amount of the increase in memory), (5) a duration for the increase (e.g., permanent or only for a predefined time period, such as 7 days, 2 weeks, 1 month, etc.), and/or other information.

When the workflow processor 214 receives the resource request, the workflow processor processes the resource request, which may be approved or denied. In either case, the workflow processor responds to the request with an accept or deny.

If the workflow processor denies the resource request for additional memory for example, the rejection is sent towards the BS 216 (via the communication service 212), but the BS 216 does not cause an increase in the allocated memory despite the need. In some embodiments, the rejection may indicate the requested amount of resource increase is rejected but the workflow processor may also include in its denial a modified (or proposed) amount of resource increase (e.g., the original request may be for 2 Gigabytes (GB) of additional memory but the modified amount may be 0.5 GB).

If the workflow processor 214 accepts the resource request for additional memory for example, the acceptance is sent towards the BS 216 via the communication service 212. The BS may then send, via the communication service 212, a request to the CIS 220 to increase the allocated memory. In response to receiving this request, the CIS 220 sends a request to the corresponding cloud platform, such as cloud platform 110A, to scale up the allocated memory at 110A for the database instance(s). When the cloud platform 110A completes the scale up, the cloud platform may provide an update to the resource usage information 221 at the CIS 220. This update to the resource usage information 221 is then published to subscribers including the BS 216. Moreover, the BS 216 may then generate a ticket to document the change (e.g., the increase in memory for the entity or application class (e.g., database instances of the entity). The ticket may be stored at a ticket database 226B and sent via a variety of mechanisms to consumers via email 226A, SMS 226C, and the like. For example, email 226A may be used to notify respective users about requests for quota scale up, approvals before or when a resource reaches a threshold of its quota.

Although some of the examples refer to the scale up or scale down of memory resources, the resources may be of other types, such as allocated processors, network bandwidth, disk storage, total quantity of instances, and/or the like.

To illustrate with another example, the allocated resources at a cloud platform are monitored to make sure that a given entity, such as company X, does not exceed the allocated resources (or quota) that has been allocated to company X at the cloud platform(s). The quotas allocated may thus represent operational limits, such as a maximum quantity of allocated CPUs, maximum memory usage, maximum network bandwidth, quantity of allowed application instances, and the like. For example, the QMA 190 may monitor and/or analyze: resource usage information provided by the cloud service platforms 222 via the cloud infrastructure service 220; and quota thresholds for an entities database instances deployed in different cloud platforms (e.g., at an AWS platform, Azure platform, and/or the like) and deployed on-premises or on a private cloud as shown at 110D. When a given quota reaches (or is predicted to reach) a threshold quota value for a given resource, the QMA may as noted trigger a process to increase the given resource.

In some embodiments, the QMA 190 may provide automated management of runtime resource consumption in a heterogeneous environment of cloud platforms 110A-D. For example, if at a given region for an entity the current threshold usage for a given resource is reached, the QMA may automatically cause upscaling of physical resources at a cloud service provider in that region to provide additional runtime resources before the actual quota is reached for that resource at that region. The QMA 190 may provide one or more of the following: provide notification regarding hardware resource limitations before the resource limitation is reached; enable cloud resources optimizations; dynamically scale in (or scale out) resources; reduce overall time required to scale up (or down) quota of resources; and/or reduce outages by anticipating resource needs before they reach the quota limit.

In some embodiments, the QMA 190 may include (or have access to): cloud platform APIs that provide information regarding an entity's accounts limits (e.g., account's allocated resources limits or sub-account allocated resources limits in one or more regions), current usage at one or more cloud service providers, assigned quota(s), remaining quota(s) (which may be global, across regions and/or regional quota(s)), additional amounts for a quota, report API(s) to enable querying for and/or providing reports regarding current usage for resources.

FIG. 2B depicts an example of a process for proactively increasing resources in a multi-cloud environment, in accordance with some embodiments.

At 250, the QMA 190 may receive resource usage information for at least a first cloud platform of a plurality of cloud platforms of a multi-cloud system. For example, the CIS 220 may provide resource usage information at the cloud providers, such as cloud platforms (also referred to as cloud service providers and cloud services) 110A-D. This resource usage information may be provided via the communication service 212. In the case of a publish and subscribe service at 212, the resource usage information is provided to the QMA whenever there is an event (new or changed resource usage information at 221, for example).

At 252, the QMA 190 may in response to the received resource usage information, the QMA (or the BS therein) may store resource usage information at for example store 218, which may be a cloud store (and/or a local store) of the QMA.

At 254, the QMA 190 may analyze the resource usage information to determine the resource usage information of a first resource exceeds a first quota threshold for the first resource. For example, the QMA may determine whether the current resource usage information for memory at the cloud service provider exceeds a quota threshold, such as 90% of the quota allocated for that first resource (which in this example is memory) at cloud platform 110A.

In response to the first quota threshold being exceeding, the QMA 190 may send, at 256, a request to the workflow processor 214 to request an increase in a quota for the first resource. The workflow processor may assess the request and accept (e.g., grant the request) or deny (e.g., reject the request) for the increase in the quota for the first resource. For example, if additional resources are available at the cloud platform 110A, the workflow processor may grant the request.

And in response to receiving a response to the request indicative of the grant of the requested increase, the QMA 190 may send, at 258, towards the first cloud platform 110A a resource request for an increase in the quota for the first resource. For example, the QMA may send the resource request indicating the increase to the CIS, which interfaces the cloud platforms 110A-D in order to obtain the increase.

In some embodiments, the CIS responds with an acknowledge message to the QMA to confirm that the first cloud platform increased the quota. Alternatively, or additionally, the QMA may store the increased quota amount in the store 218, generate a ticket 226B for the increase, and/or notify via email 226A and SMS 226C users. Alternatively, or additionally, the QMA may indicate to the service, such as service 112A, that the quota for the first resource (e.g., increase in memory) has been increased to enable the service 112A to use the additional resources.

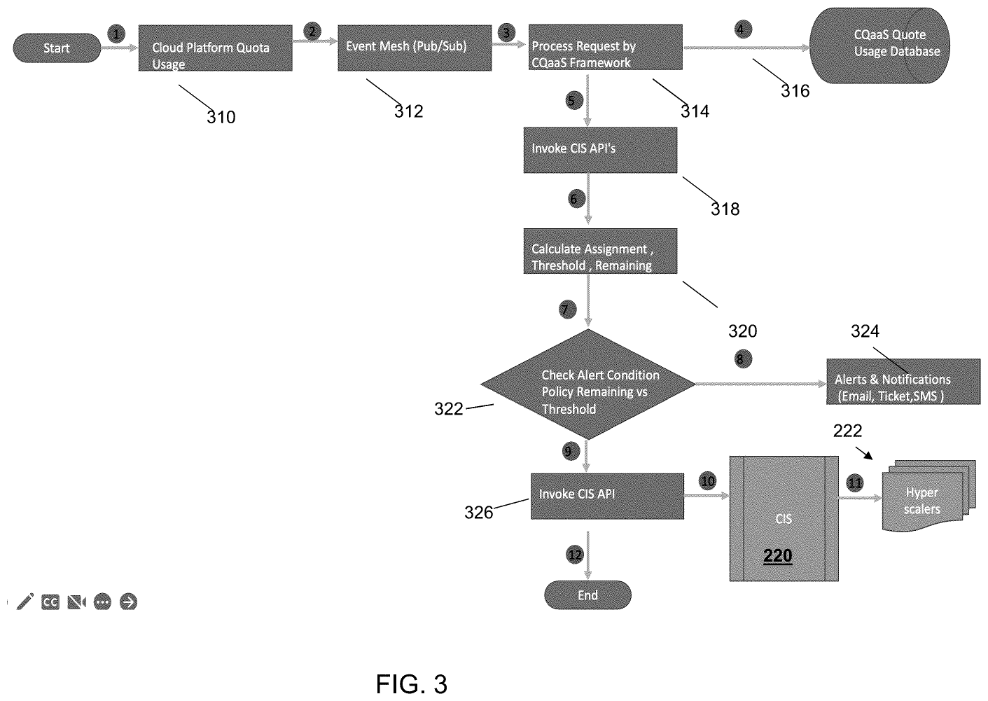

FIG. 3 depicts an example of a process 300, in accordance with some embodiments.

At 310-312, the CIS 220 may publish an amount of a resource quota consumed via the publish and subscribe service 212. The published amount of a resource quota, such a memory currently being used, processors (CPU) being used, network bandwidth being used, instances being used, and/or the like, may be sent towards subscribers including the BS 216. For an entity X at region Y operating database instances at cloud platform 110A, the CIS may publish the resource quota at the cloud platform 110A.

At 314, the BS 216 may receive, via the communication service 212, the published amount of resource quota consumed and read (from a publish and subscribe queue) the message including the amount of resource quota consumed. The message may allow the BS to determine information about the resources, such as account ID, quota consumed, and the like.

At 316, the BS 216 may also access the CIS 220 to determine additional information about the account ID associated with the received message. For example, the BS may access the CIS via an API to obtain information, such as account limit, assigned quota, quota usage, and/or other information. For example, the system may invoke the CIS's API to know a requested account limit, assigned usage quota(s), updated usage quota, and the like. The system may then calculate a remaining quota of the cloud account by for example accessing and/or interacting with a CIS system database. This interaction may provide real time quota information of cloud accounts of a given client/customer.

At 318, the BS 216 calls the CIS 220 API to get HyperScaler Platform Quota details. For example, the CIS may include so-called “ground truth” information for the QMA as the CIS has interactions (e.g., accesses) with multi-cloud. The BS 216 (backend of QMA) may include a process to calculate an assigned quota, a remaining quota, a consumption (or usage), and/or the like, which may be stored in a QMA database store 218. The BS 216 may be based on rules configured by client/customer. If for example consumption of a quota is less than a threshold amount (e.g., 75%), a message may be sent to the CIS. If an action is taken, the QMA database may be updated. If consumption is less than a threshold of for example 90%, a “critical” message may be sent to CIS to create an urgent alert. In this example, the BS 215 may automatically handle quota management based on policies defined in the QMA.

At 320, the BS 216 may update information stored at the store 218, such as information regarding entries of the cloud account quota (e.g., amount of quota being used, amount of quota remaining, amount of quota assigned, and the quota threshold value). The store 218 may thus provide local information that can be used when the CIS cannot be accessed and/or as an audit mechanism against the CIS's information.

At 322, the BS 216 checks its rules to see if a threshold conditions to see if the resource usage exceeds the threshold quota amount for a given resource. If a rule indicates a threshold condition is satisfied, the BS may trigger (at 324) at least one alert (and/or at least one notification), which may be in the form of email 226A, SMS 226C, and/or a ticket 226B.

At 326, the BS 216 may access the CIS to request an increase in the allocated resources, when the resource threshold is exceeded. The CIS may then interface and request from a cloud service provider (e.g., a hyperscaler or orchestrator therein) to increase the allocation.

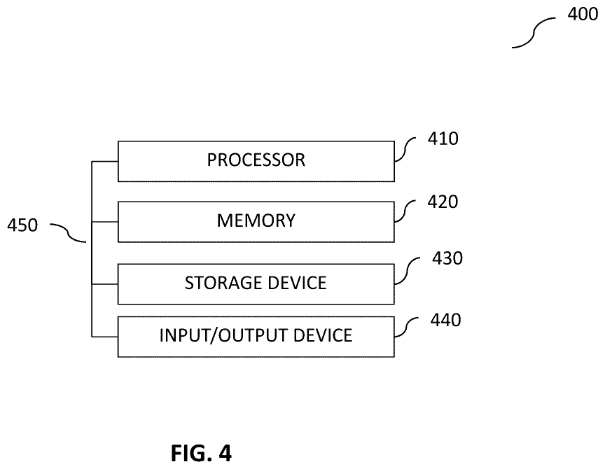

In some implementations, the current subject matter may be configured to be implemented in a system 400, as shown in FIG. 4. For example, the QMA 190, clients 140A_C, cloud platforms 110A-D, and/or other aspects disclosed herein may be at least in part physically comprise or be comprised in system 400. To illustrate further system 400 may further an operating system, a hypervisor, and/or other resources, to provide virtualize physical resources (e.g., via virtual machines). The system 400 may include a processor 410, a memory 420, a storage device 430, and an input/output device 440. Each of the components 410, 420, 430 and 440 may be interconnected using a system bus 450. The processor 410 may be configured to process instructions for execution within the system 400. In some implementations, the processor 410 may be a single-threaded processor. In alternate implementations, the processor 410 may be a multi-threaded processor.

The processor 410 may be further configured to process instructions stored in the memory 420 or on the storage device 430, including receiving or sending information through the input/output device 440. The memory 420 may store information within the system 400. In some implementations, the memory 420 may be a computer-readable medium. In alternate implementations, the memory 420 may be a volatile memory unit. In yet some implementations, the memory 420 may be a non-volatile memory unit. The storage device 430 may be capable of providing mass storage for the system 400. In some implementations, the storage device 430 may be a computer-readable medium. In alternate implementations, the storage device 430 may be a floppy disk device, a hard disk device, an optical disk device, a tape device, non-volatile solid state memory, or any other type of storage device. The input/output device 440 may be configured to provide input/output operations for the system 400. In some implementations, the input/output device 440 may include a keyboard and/or pointing device. In alternate implementations, the input/output device 440 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method, comprising: receiving, at a quota management application, resource usage information for at least a first cloud platform of a plurality of cloud platforms of a multi-cloud system; in response to the received resource usage information, storing, by the quota management application, the resource usage information to provide local use of the resource usage information; analyzing, at the quota management application, the resource usage information to determine the resource usage information of a first resource at the first cloud platform exceeds a first quota threshold for the first resource; in response to the first quota threshold being exceeded, sending, by the quota management application, a request to a workflow processor to request an increase in a quota for the first resource; and in response to receiving a response to the request indicative of a grant of the increase, sending, by the quota management application, a resource request towards the first cloud platform, wherein the resource request indicates the increase in the quota for the first resource.

Example 2: The computer-implemented method of Example 1, wherein the quota management application includes a front-end component, a backend component, a database, a communication service, and the workflow processor.

Example 3: The computer implemented method of any of Examples 1-2, wherein the front end component provides an interface to view, control, monitor, and/or access resource usage at the plurality of cloud platforms of the multi-cloud system.

Example 4: The computer implemented method of any of Examples 1-3, wherein the front end component provides via the interface a centralized dashboard to view and monitor the resource usage information at the plurality of cloud platforms of the multi-cloud system, wherein the resource usage information includes a current amount of database instances, a current amount of processor being used, a current amount of memory being used, a current amount of storage being used, and a current amount network bandwidth being used.

Example 5: The computer-implemented method of any of Examples 1-4, wherein the backend component includes one or more rules to monitor and analyze the resource usage information at the plurality of cloud platforms of the multi-cloud system.

Example 6: The computer implemented method of any of Examples 1-5, wherein the communication service provides an interface with at least an infrastructure service to centralize access to the plurality of cloud platforms of the multi-cloud system.

Example 7: The computer implemented method of any of Examples 1-6, wherein the communication service comprises a publish and subscribe system between the quota management application and the plurality of cloud platforms.

Example 8: The computer implemented method of any of Examples 1-7, wherein the resource usage information for at least the first cloud platform is received as a publish and subscribe message from the infrastructure service, wherein the publish and subscribe message is published by the infrastructure service in response to a change to the resource usage information at the first cloud platform.

Example 9: The computer implemented method of any of Examples 1-8, wherein the database provides a local store for the resource usage information, the first quota threshold, and the one or more rules to monitor and analyze the resource usage information at the plurality of cloud platforms of the multi-cloud system.

Example 10: The computer implemented method of any of Examples 1-9, further comprising: in response to receiving the response to the request indicative of the grant of the increase, sending, by the quota management application, a message to application using the first resource, the message indicating to the application of the increase in the quota for the first resource to enable the application to use the increase.

Example 11: A system comprising: at least one processor; and at least one memory including code which when executed by the at least one processor causes operations comprising: receiving, at a quota management application, resource usage information for at least a first cloud platform of a plurality of cloud platforms of a multi-cloud system; in response to the received resource usage information, storing, by the quota management application, the resource usage information to provide local use of the resource usage information; analyzing, at the quota management application, the resource usage information to determine the resource usage information of a first resource at the first cloud platform exceeds a first quota threshold for the first resource; and in response to the first quota threshold being exceeded, sending, by the quota management application, a request to a workflow processor to request an increase in a quota for the first resource; and in response to receiving a response to the request indicative of a grant of the increase, sending, by the quota management application, a resource request towards the first cloud platform, wherein the resource request indicates the increase in the quota for the first resource.

Example 12: The system of Example 11, wherein the quota management application includes a front-end component, a backend component, a database, a communication service, and the workflow processor.

Example 13: The system of any of Examples 11-12, wherein the front end component provides an interface to view, control, monitor, and/or access resource usage at the plurality of cloud platforms of the multi-cloud system.

Example 14: The system of any of Examples 11-13, wherein the front end component provides via the interface a centralized dashboard to view and monitor the resource usage information at the plurality of cloud platforms of the multi-cloud system, wherein the resource usage information includes a current amount of database instances, a current amount of processor being used, a current amount of memory being used, a current amount of storage being used, and a current amount network bandwidth being used.

Example 15: The system of any of Examples 11-14, wherein the backend component includes one or more rules to monitor and analyze the resource usage information at the plurality of cloud platforms of the multi-cloud system.

Example 16: The system of any of Examples 11-15, wherein the communication service provides an interface with at least an infrastructure service to centralize access to the plurality of cloud platforms of the multi-cloud system.

Example 17: The system of any of Examples 11-16, wherein the communication service comprises a publish and subscribe system between the quota management application and the plurality of cloud platforms.

Example 18: The system of any of Examples 11-17, wherein the resource usage information for at least the first cloud platform is received as a publish and subscribe message from the infrastructure service, wherein the publish and subscribe message is published by the infrastructure service in response to a change to the resource usage information at the first cloud platform.

Example 19: The system of any of Examples 11-18, further comprising: in response to receiving a response to the request indicative of a grant of the increase, sending, by the quota management application, a message to application using the first resource, the message indicating to the application of the increase in the quota for the first resource to enable the application to use the increase.

Example 20: A non-transitory computer-readable storage medium including code which when executed by at least one processor causes operations comprising: receiving, at a quota management application, resource usage information for at least a first cloud platform of a plurality of cloud platforms of a multi-cloud system; in response to the received resource usage information, storing, by the quota management application, the resource usage information to provide local use of the resource usage information; analyzing, at the quota management application, the resource usage information to determine the resource usage information of a first resource at the first cloud platform exceeds a first quota threshold for the first resource; in response to the first quota threshold being exceeded, sending, by the quota management application, a request to a workflow processor to request an increase in a quota for the first resource; and in response to receiving a response to the request indicative of a grant of the increase, sending, by the quota management application, a resource request towards the first cloud platform, wherein the resource request indicates the increase in the quota for the first resource.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, at a quota management application, resource usage information for at least a first cloud platform of a plurality of cloud platforms of a multi-cloud system;
in response to the received resource usage information, storing, by the quota management application, the resource usage information to provide local use of the resource usage information;
analyzing, at the quota management application, the resource usage information to determine the resource usage information of a first resource at the first cloud platform exceeds a first quota threshold for the first resource;
in response to the first quota threshold being exceeded, sending, by the quota management application, a request to a workflow processor to request an increase in a quota for the first resource; and
in response to receiving a response to the request indicative of a grant of the increase, sending, by the quota management application, a resource request towards the first cloud platform, wherein the resource request indicates the increase in the quota for the first resource.

2. The computer-implemented method of claim 1, wherein the quota management application includes a front-end component, a backend component, a database, a communication service, and the workflow processor.

3. The computer implemented method of claim 2, wherein the front end component provides an interface to view, control, monitor, and/or access resource usage at the plurality of cloud platforms of the multi-cloud system.

4. The computer implemented method of claim 2, wherein the front end component provides via the interface a centralized dashboard to view and monitor the resource usage information at the plurality of cloud platforms of the multi-cloud system, wherein the resource usage information includes a current amount of database instances, a current amount of processor being used, a current amount of memory being used, a current amount of storage being used, and a current amount network bandwidth being used.

5. The computer-implemented method of claim 4, wherein the backend component includes one or more rules to monitor and analyze the resource usage information at the plurality of cloud platforms of the multi-cloud system.

6. The computer implemented method of claim 2, wherein the communication service provides an interface with at least an infrastructure service to centralize access to the plurality of cloud platforms of the multi-cloud system.

7. The computer implemented method of claim 6, wherein the communication service comprises a publish and subscribe system between the quota management application and the plurality of cloud platforms.

8. The computer implemented method of claim 6, wherein the resource usage information for at least the first cloud platform is received as a publish and subscribe message from the infrastructure service, wherein the publish and subscribe message is published by the infrastructure service in response to a change to the resource usage information at the first cloud platform.

9. The computer implemented method of claim 2, wherein the database provides a local store for the resource usage information, the first quota threshold, and the one or more rules to monitor and analyze the resource usage information at the plurality of cloud platforms of the multi-cloud system.

10. The computer implemented method of claim 1, further comprising:
in response to receiving the response to the request indicative of the grant of the increase, sending, by the quota management application, a message to application using the first resource, the message indicating to the application of the increase in the quota for the first resource to enable the application to use the increase.

11. A system comprising:
at least one processor; and
at least one memory including code which when executed by the at least one processor causes operations comprising:
receiving, at a quota management application, resource usage information for at least a first cloud platform of a plurality of cloud platforms of a multi-cloud system;
in response to the received resource usage information, storing, by the quota management application, the resource usage information to provide local use of the resource usage information;
analyzing, at the quota management application, the resource usage information to determine the resource usage information of a first resource at the first cloud platform exceeds a first quota threshold for the first resource;
in response to the first quota threshold being exceeded, sending, by the quota management application, a request to a workflow processor to request an increase in a quota for the first resource; and
in response to receiving a response to the request indicative of a grant of the increase, sending, by the quota management application, a resource request towards the first cloud platform, wherein the resource request indicates the increase in the quota for the first resource.

12. The system of claim 11, wherein the quota management application includes a front-end component, a backend component, a database, a communication service, and the workflow processor.

13. The system of claim 12, wherein the front end component provides an interface to view, control, monitor, and/or access resource usage at the plurality of cloud platforms of the multi-cloud system.

14. The system of claim 12, wherein the front end component provides via the interface a centralized dashboard to view and monitor the resource usage information at the plurality of cloud platforms of the multi-cloud system, wherein the resource usage information includes a current amount of database instances, a current amount of processor being used, a current amount of memory being used, a current amount of storage being used, and a current amount network bandwidth being used.

15. The system of claim 14, wherein the backend component includes one or more rules to monitor and analyze the resource usage information at the plurality of cloud platforms of the multi-cloud system.

16. The system of claim 12, wherein the communication service provides an interface with at least an infrastructure service to centralize access to the plurality of cloud platforms of the multi-cloud system.

17. The system of claim 16, wherein the communication service comprises a publish and subscribe system between the quota management application and the plurality of cloud platforms.

18. The system of claim 16, wherein the resource usage information for at least the first cloud platform is received as a publish and subscribe message from the infrastructure service, wherein the publish and subscribe message is published by the infrastructure service in response to a change to the resource usage information at the first cloud platform.

19. The system of claim 11, further comprising:
in response to receiving a response to the request indicative of a grant of the increase, sending, by the quota management application, a message to application using the first resource, the message indicating to the application of the increase in the quota for the first resource to enable the application to use the increase.

20. A non-transitory computer-readable storage medium including code which when executed by at least one processor causes operations comprising:
receiving, at a quota management application, resource usage information for at least a first cloud platform of a plurality of cloud platforms of a multi-cloud system;
in response to the received resource usage information, storing, by the quota management application, the resource usage information to provide local use of the resource usage information;
analyzing, at the quota management application, the resource usage information to determine the resource usage information of a first resource at the first cloud platform exceeds a first quota threshold for the first resource;
in response to the first quota threshold being exceeded, sending, by the quota management application, a request to a workflow processor to request an increase in a quota for the first resource; and
in response to receiving a response to the request indicative of a grant of the increase, sending, by the quota management application, a resource request towards the first cloud platform, wherein the resource request indicates the increase in the quota for the first resource.
